(19) United States
(12) Patent Application Publication
(10) Pub. No.: US 2007/0008057 A1
(43) Pub. Date: Jan. 11, 2007

(54) TRANSFORMER WITH REGULATING COMPONENT

(75) Inventor: Elmer Lewis Griebeler, Chesterland, OH (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: ZIN TECHNOLOGIES, Brook Park, OH (US)

(21) Appl. No.: 11/421,362

(22) Filed: May 31, 2006

Related U.S. Application Data
(60) Provisional application No. 60/696,698, filed on Jul. 5, 2005.

(51) Int. Cl. H01F 27/28

(52) U.S. Cl. 336/182

(57) ABSTRACT

Systems and methodologies that regulate a transformer's magnetic field (and attributes dependent thereupon, such as voltage, current, impedance and the like), via employing a control component(s) that affect the magnetic path between the primary and secondary winding of the transformer. Such control component can include ferric material and wire winding component(s) that can decouple the magnetic flux between the primary and secondary winding, wherein the path of the magnetic field thru the transformer is affected via a selective short of the voltage that is induced in the wire winding component associated with the control component.

### CROSS-REFERENCE TO RELATED APPLICATIONS

This is an application claiming the benefit under 35 U.S.C. § 119(e) of U.S. Provisional Patent Application Ser. No. 60/696,698 filed on Jul. 5, 2005. The entirety of the aforementioned application is hereby incorporated by reference.

### GOVERNMENT INTERESTS

This subject invention is developed with government support under Contract No. NAS3-00145 awarded by NASA. The United States government has certain rights in the invention.

### BACKGROUND

Transformers are used extensively in electrical and electronic applications. Transformers can be employed to: step voltages up or down, couple signal energy from one stage to another, and for impedance matching. Transformers are also useful for sensing current and powering electronic trip units for circuit interrupters such as circuit breakers and other electrical distribution devices. Generally, the transformer can transfer electric energy from one circuit to another circuit via magnetic induction, e.g., for transferring energy of an alternating current in a primary winding of the transformer to that in one or more secondary windings.

Such primary and secondary windings can each be made of a multi-turn coil of electrical conductors with one or more magnetic cores coupling the coils by transferring a magnetic flux therebetween. By varying the number of turns contained in the primary winding with respect to the number of turns contained in the secondary winding, the output voltage of the transformer can be easily increased or decreased.

For example, the electrical transformer can comprise two “E”-shaped ferrite structures and a set of coiled wires (e.g., to form one primary coil and at least one secondary coil). The sets of coils are wound around the center leg of one of the E-shaped structures, after which the two E-shaped ferrite structures are bonded together to form the transformer.

The magnetic field generated by the current in the primary coil or winding can be greatly concentrated by providing a core of magnetic material on which the primary and secondary coils are wound. This increases the inductance of the primary and secondary coils so that a smaller number of turns can be used. A closed core having a continuous magnetic path also ensures that practically all of the magnetic field established by the current in the primary coil will be induced in the secondary coil.

When an alternating voltage is applied to the primary winding, an alternating current flows, limited in value by the inductance of the winding. This magnetizing current produces an alternating magnetomotive force that creates an alternating magnetic flux. The flux is constrained within the magnetic core of the transformer and induces voltage in the linked secondary winding, which, if it is connected to an electrical load, produces an alternating current. This secondary load current then produces its own magnetomotive force and creates a further alternating flux which links back with the primary winding. A load current then flows in the primary winding of sufficient magnitude to balance the magnetomotive force produced by the secondary load current. Thus, the primary winding can carry both magnetizing and load current, the secondary winding carries load current, and the magnetic core carries the flux produced by the magnetizing current.

In such transformers, regulating the transformer (e.g., switching the transformer between “On” and “Off” modes can create electromagnetic waves that interferes with the surrounding environment (electromagnetic interference—EMI). For example, such EMI can cause medical monitors and other hospital devices to malfunction. Such susceptible devices are typically required to be placed at safe distances or relocated, thus burdening the design layout in these locations.

Moreover, the switching circuitry involved in regulating transformers typically cannot be designed with simplicity for operation in high radiation environments. For example, in outer-space applications the components associated with the regulation circuit can be subject to high radiation, which can increase complexity and/or hinder efficient design for the circuit.

Therefore, there is a need to overcome the aforementioned exemplary deficiencies associated with conventional systems and devices.

### SUMMARY

The following presents a simplified summary of the innovation in order to provide a basic understanding of one or more aspects of the innovation. This summary is not an extensive overview of the innovation. It is intended to neither identify key or critical elements of the innovation, nor to delineate the scope of the subject innovation. Rather, the sole purpose of this summary is to present some concepts of the innovation in a simplified form as a prelude to the more detailed description that is presented hereinafter.

The subject innovation provides for systems and methods of regulating a magnetic field (and attributes dependent thereupon, such as voltage, current, impedance and the like) associated with a transformer, via employing a control component that affects the magnetic path between a primary and secondary winding of the transformer (e.g., by varying electromagnetic coupling). Such control component can include ferric material and wire winding component(s) that can couple/decouple the magnetic flux between the primary and secondary winding, wherein the path of the magnetic field thru the transformer is affected via a selective short of the voltage that is induced in the wire winding component associated with the control component, for example.

Such regulation of the transformer can: mitigate electromagnetic interference (EMI); simplify transformer switch/control circuitry; increase reliability; lower part costs; increase efficiency and provide for application of the transformer in high radiation environments (e.g., outer space). It is to be appreciated that the control component can be designed to block a desired portion (e.g., total or partial blockage of N %, where N can be an integer) of the electromagnetic field between the primary and secondary winding, and readily enable flow for the remaining portion of the electromagnetic field.

According to a further aspect, at least two paths can be provided for conveying the magnetic flow from the primary winding within the transformer, wherein one path leads to the secondary coil of the transformer for a powering thereof. The control component can distribute the magnetic flux between the at least two paths. For example, the control component can include a plate that is positioned between the primary winding and the secondary winding. Such plate can include a plurality of windings operatively connected thereto, which facilitate a magnetic flow from the primary winding of the transformer through the plate, and away from the secondary winding, to shut down the transformer (e.g., the control component distributes substantially all the magnetic flux into the plate, with minimal or substantially no distribution of the magnetic flux into the secondary winding.) By supplying a short in the induced voltages created in the plate and/or associated windings (e.g., via lead wires to the windings of the plate), the magnetic flux can be enticed to be picked up by the secondary winding of the transformer (e.g., the magnetic field takes a longer path), and hence the transformer can be turned on (e.g., the control component distributes substantially all the magnetic flux into the secondary winding, with minimal or substantially no distribution of the magnetic flux into the plate.) Various artificial intelligence components can also be employed in conjunction with facilitating the distribution of the magnetic flux among the at least two paths.

In a further aspect of the subject innovation, the arrangement for: the control component, the primary coil, and the secondary coil of the transformer can be such that to enable a magnetic coupling in substantially a same plane, and avoid a gap in the magnetic path to be controlled. For example, the primary winding can surround the control component and the secondary winding in a same plane of magnetic coupling. Moreover, control of the magnetic flux of the subject innovation (e.g., via cross section selection of associated ferrite material) can be such as to avoid a saturation of cores associated with the transformer/control component. Such can mitigate: a distortion of the material and reduce corresponding losses. A plurality of such transformers can be electrically connected and aligned as part of a multiple output operation. Moreover, the transformer of the subject innovation can be employed as part of regulating three phase AC power with a high power voltage supply.

To the accomplishment of the foregoing and related ends, the innovation, then, comprises the features hereinafter fully described. The following description and the annexed drawings set forth in detail certain illustrative aspects of the innovation. However, these aspects are indicative of but a few of the various ways in which the principles of the innovation may be employed. Other aspects, advantages and novel features of the innovation will become apparent from the following detailed description of the innovation when considered in conjunction with the drawings. It is to be appreciated that various portions of the drawings are not to scale.

### BRIEF DESCRIPTION OF THE DRAWINGS

FIG. 1 illustrates a schematic block diagram of a transformer arrangement in accordance with an aspect of the subject innovation.

FIG. 2 illustrates an exemplary magnetic flux distribution among a primary winding, a control component and a secondary component of a transformer in accordance with an aspect of the subject innovation.

FIG. 3 illustrates another magnetic flux distribution in a transformer according to a further aspect of the subject innovation.

FIG. 4 illustrates a magnetic flux distribution in a transformer with an “on” condition for a control component.

FIG. 5 illustrates a magnetic path in a transformer according to an aspect of the subject innovation.

FIG. 6 illustrates a magnetic path in a transformer in an “Off” position in accordance with an exemplary aspect of the subject innovation.

FIG. 7 illustrates a magnetic path in a transformer in an “On” position in accordance with a particular aspect of the subject innovation.

FIG. 8 illustrates exemplary cross sections of a control plate implemented as part of a transformer in accordance with an aspect of the subject innovation.

FIG. 9 illustrates exemplary cross sections of a transformer according to the subject innovation.

FIG. 10 illustrates yet a further cross section with design specification associated with a transformer of the subject innovation.

FIG. 11 illustrates a flow chart of distributing a magnetic flux in accordance with an aspect of the subject innovation.

FIG. 12 illustrates a further methodology for creating at least two magnetic paths within a transformer in accordance with an aspect of the subject innovation.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the subject innovation may be practiced without these specific details. In other instances, well-known structures and devices are shown in block diagram form in order to facilitate describing the subject innovation.

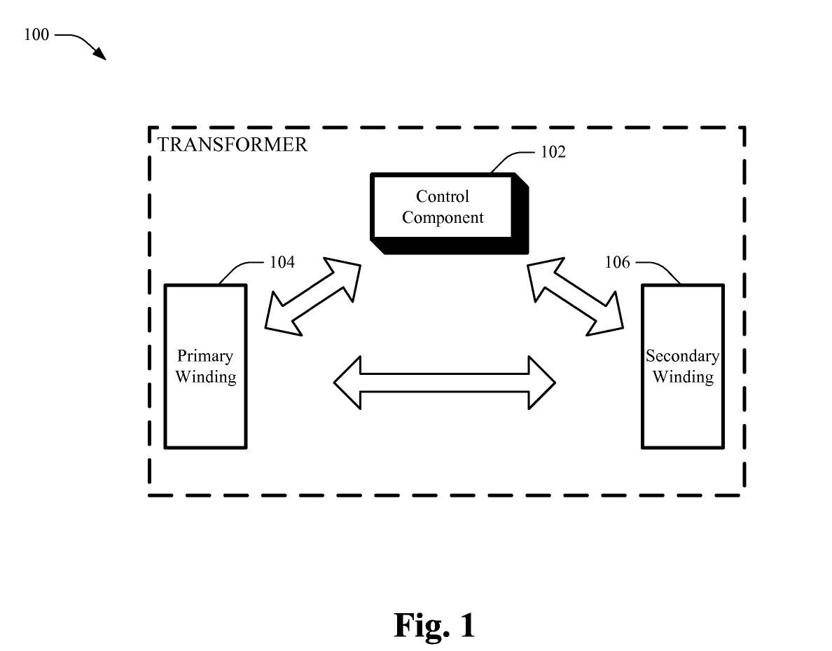

The subject innovation provides for regulating a magnetic field (and attributes dependent thereupon, such as voltage, current, impedance and the like) associated with a transformer, via employing a control component(s) that affects the magnetic path between a primary and secondary winding of the transformer. As illustrated in FIG. 1, the transformer 100 can include a primary winding 104 and a secondary winding 106 that interact with a control component 102. The control component 102 can include ferric material and wire winding component(s) that can decouple the magnetic flux between the primary winding 104 and secondary winding 106, wherein the path of the magnetic field thru the transformer 100 is affected via the control component 102. Such regulation of the transformer 100 via the control component 102 can: mitigate electromagnetic interference (EMI); simplify transformer switch/control circuitry; increase reliability; lower part costs; increase efficiency and provide for application of the transformer in high radiation areas (e.g., outer space).

The control component 102 can provide for a flux bypass path between the primary winding 104 and secondary winding component 106. The primary winding 104 can be a high voltage primary and the secondary winding component can include a secondary winding that can be isolated for 5000 VDC to step up the voltage.

As such, at least two paths can be provided for conveying the magnetic flow from the primary winding 104 within the transformer 100, wherein one path leads to the secondary winding component 106 of the transformer 100 for a powering thereof.

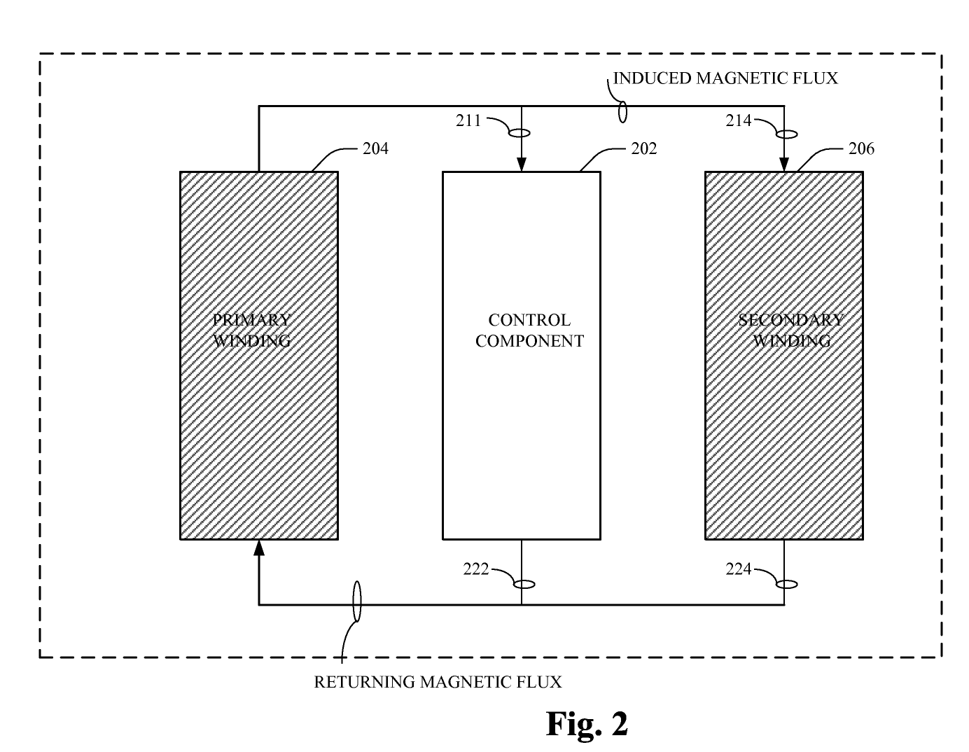

FIG. 2 illustrates a primary winding 204 that can be energized by an external alternating voltage power source (not shown). Likewise, the control component 202 can be connected to an external circuit that can turn such control component 202 “on” or “off”. Also, the secondary winding 206 can be connected to an external load. Accordingly, an induced magnetic flux from the primary winding 204 can travel through two paths, namely: a path 211 that passes through the control component, or via a path 214 that travels through the secondary winding 206, and/or a combination of both paths (e.g., selectively distributing predetermined portion of the magnetic flux in path 211, and a remainder of the magnetic flux through path 214).

Subsequently, and after passing through the control component 202 and/or the secondary winding 206, the magnetic flux returns through the bottom path(s) 224, to the primary winding 204. Since the power source can be an alternating voltage, the magnetic flux alternates direction every half cycle.

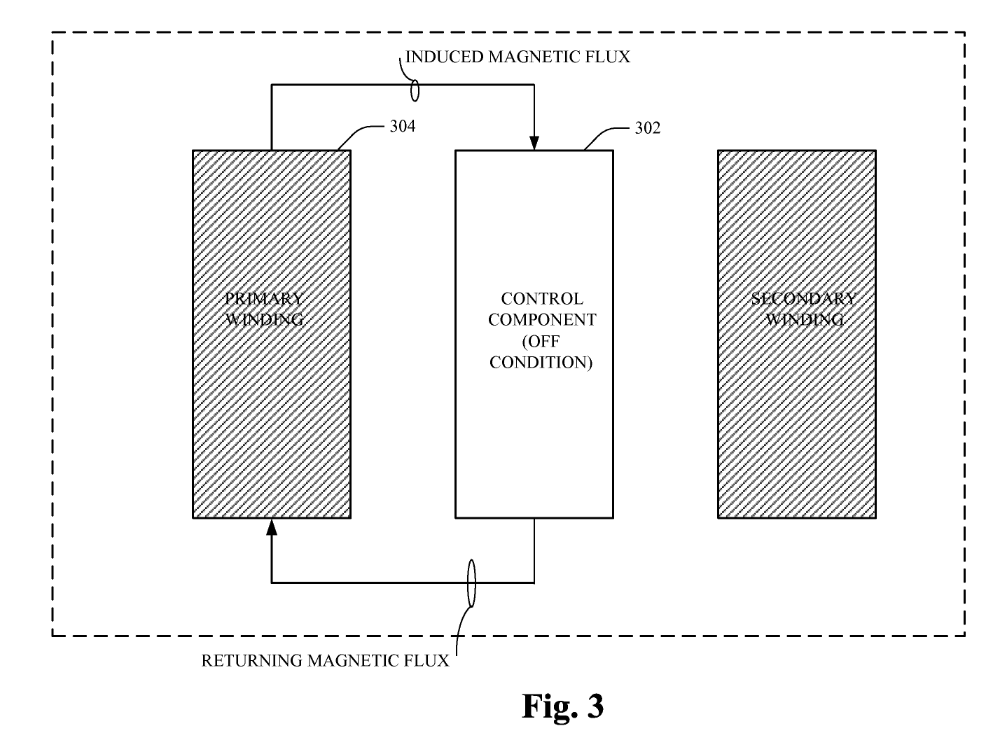

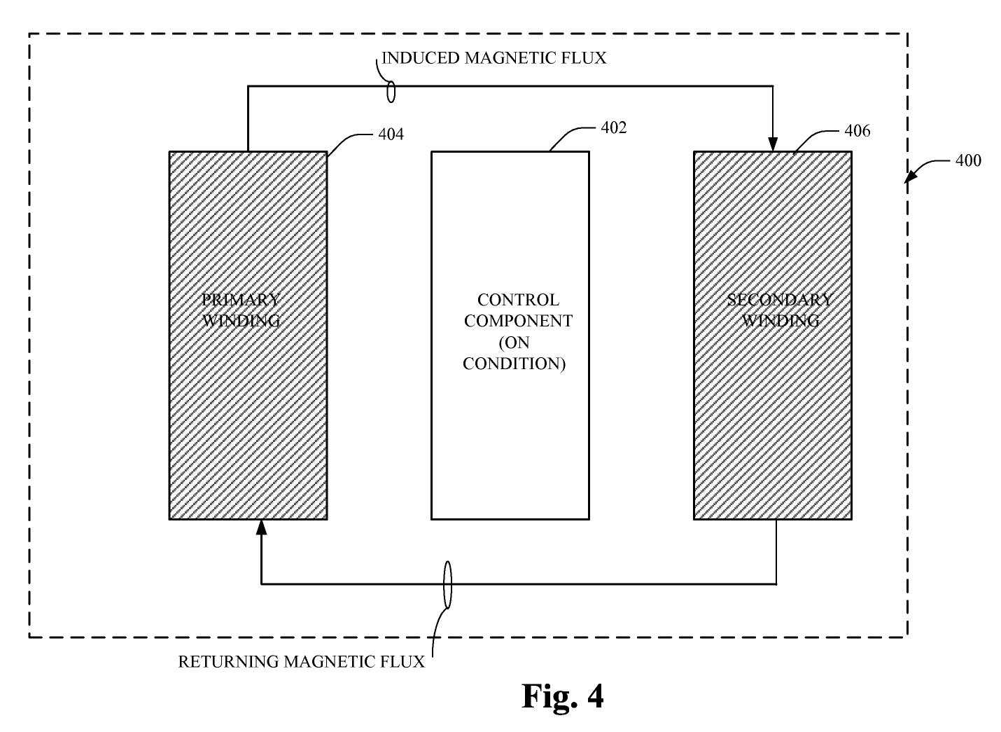

FIG. 3 illustrates a particular aspect of a transformer in accordance with an aspect of the subject innovation, wherein the control component 302 is being turned “off”. Such can divert the magnetic flux from the primary winding 304 through the control component 302 and therefore the transformer coupling is “off”. Likewise, FIG. 4 illustrates a further particular aspect for the transformer 400, wherein the control component 402 is being turned “on”, to enable passage of the magnetic flux from the primary winding 404 to reach the secondary winding 406, and allow power to pass through the transformer and out to the load. (As explained earlier with reference to FIG. 3, when the control component is turned off, the magnetic flux can then be directed to pass therein, via predetermining the location of the control component, to intercept the magnetic flux.)

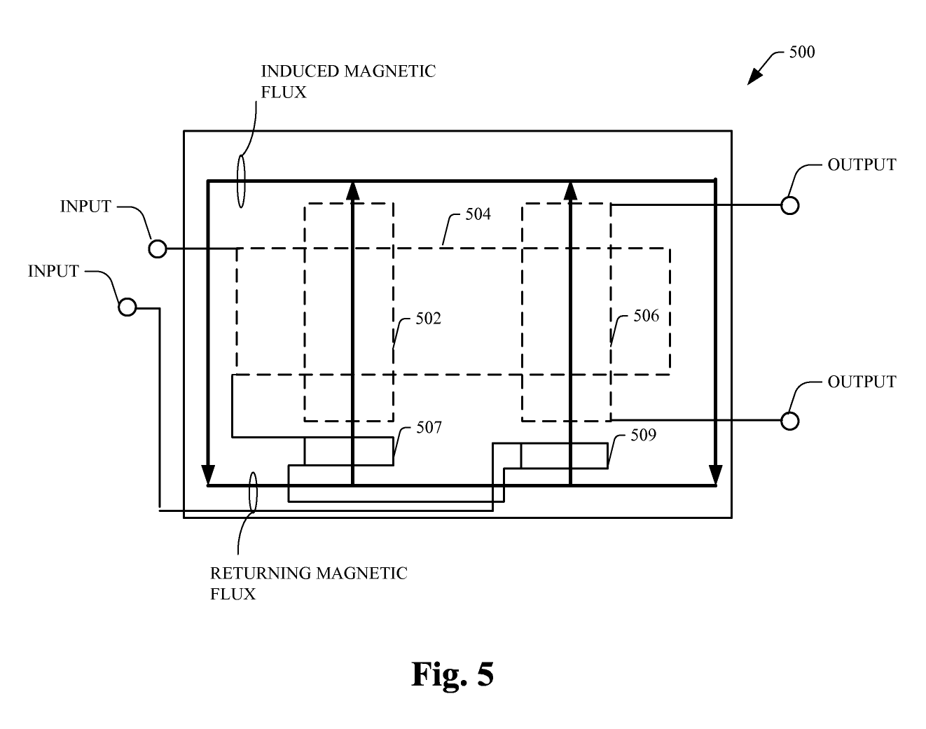

Referring now to FIG. 5 there is illustrated a transformer 500 in accordance with an aspect of the subject innovation, wherein the control component 502 and the secondary winding 506 are positioned side-by-side. In such configuration, the primary winding 504 is being wound around the control component 502 and the secondary winding 506. Such can facilitate inducing a return magnetic path around an outside of the assembly 500. Two smaller windings can also be added, namely a helper winding 507 and a retarding winding 509. In general, such windings 507, 509 supply the magnetic flux with a preference so that substantially all such flux passes through the control component when the control component is turned off.

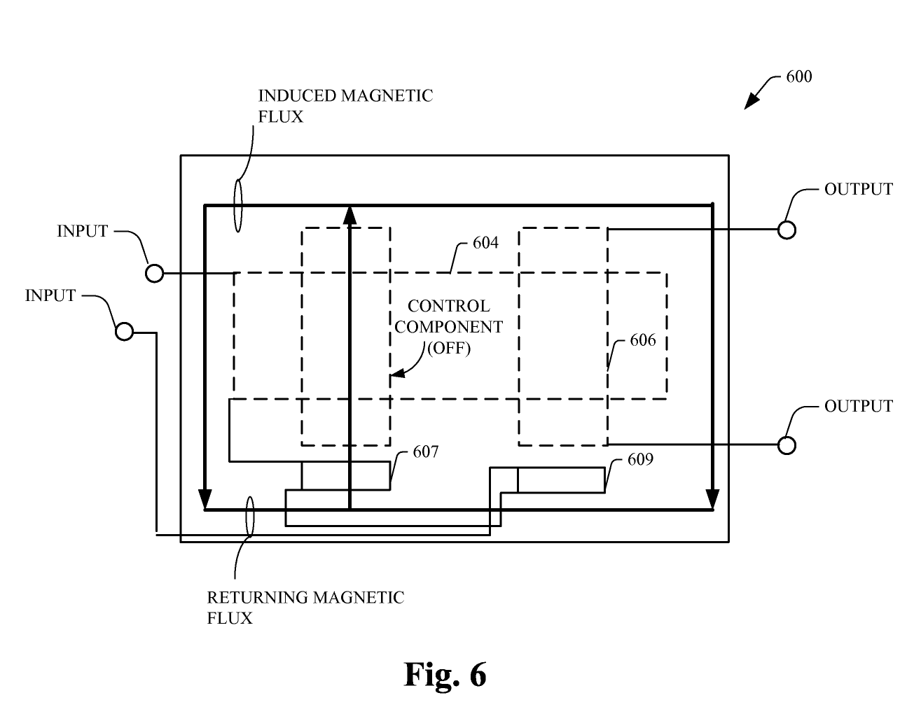

For example, FIG. 6 illustrates a transformer 600 with the control component turned off. In general, the magnetic induction from the primary winding 604 can produce magnetic flux in the control component and/or the secondary winding. The helper winding 607 can add a small boost to the magnetic induction in the path through the control component, and the retarding winding 609 can subtract from the magnetic induction through the secondary winding 606. Accordingly, when the control component is turned off, typically no magnetic flux from the primary winding 604 passes through the secondary winding 606.

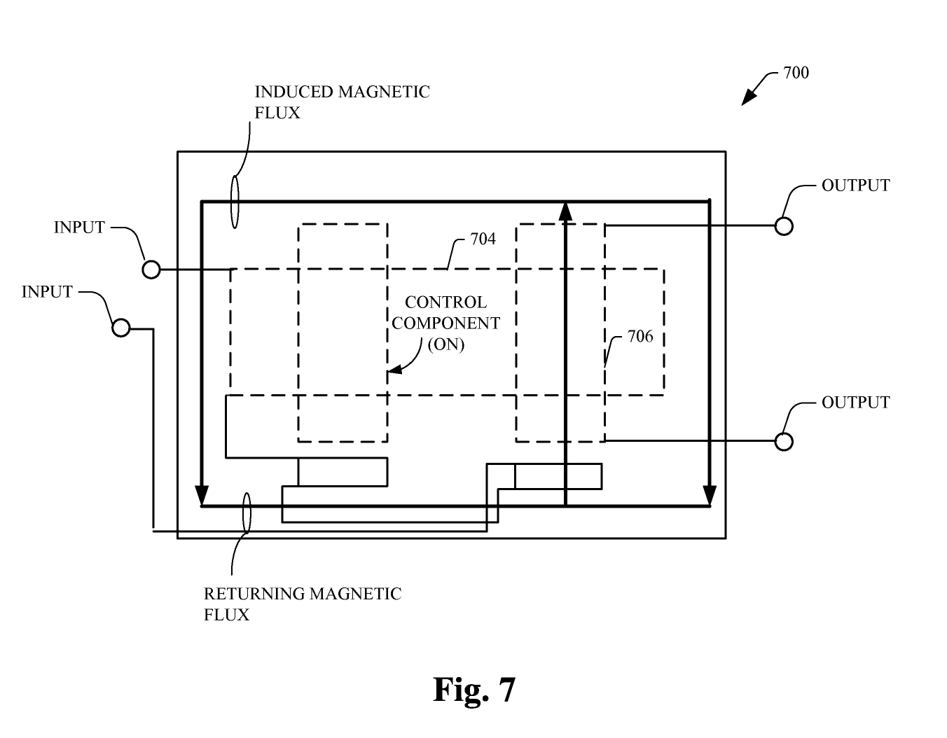

Similarly, FIG. 7 illustrates a transformer 700 with the control component turned on. The induction from the primary winding 704 sets up the magnetic flux now in the secondary winding 706, which allows power to pass through the transformer 700 and out to the load.

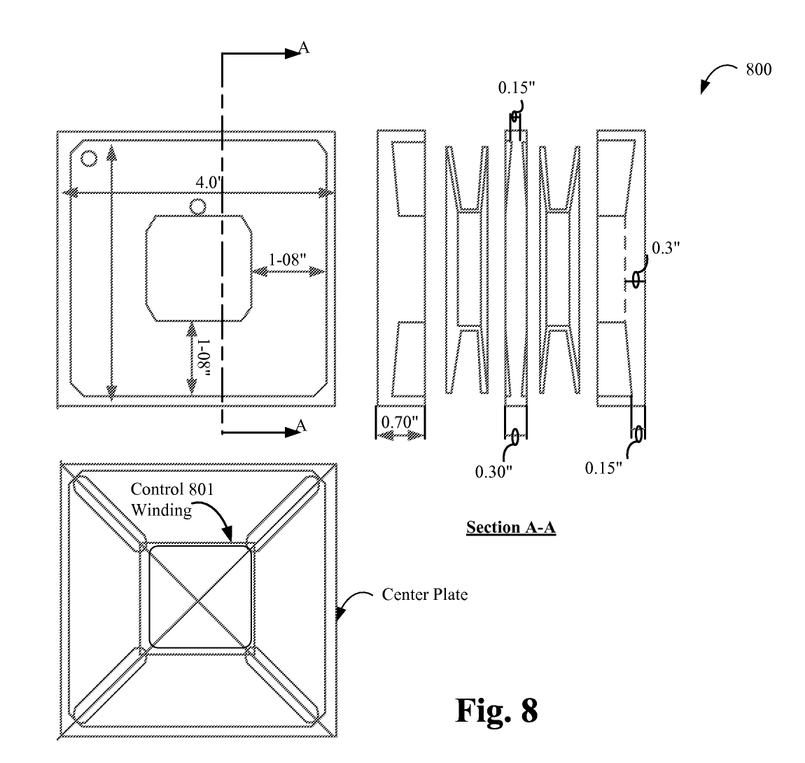

FIG. 8 illustrates an exemplary control component that includes a plate(s) 800 positioned between the primary winding and the secondary winding component. Such plate can include a plurality of windings 801 operatively connected thereto, which facilitate a magnetic flow from the primary winding of the transformer through the plate, and away from the secondary winding, to shut down the transformer. By supplying a short in the induced voltages created in the plate and/or associated windings (e.g., via lead wires to the windings of the plate), the magnetic flux can be enticed to be picked up by the secondary winding of the transformer (e.g., the magnetic field takes a longer path), and hence the transformer can be turned on. It is to be appreciated that the control component can be designed to block a desired portion (e.g., partial blockage) of the electromagnetic field between the primary and secondary winding, and readily enable flow for the remaining portion of the electromagnetic field.

For example, the transformer of the subject innovation can employ “E” cores, wherein the primary coil can be wound around the center leg of one of the “E” cores. The secondary coil can be wound around the center leg of the other “E” core. Accordingly, open sides of each “E” core can then face each other to form the transformer. Moreover, the control component can include an “I” core that is inserted between the “E” cores. The control component can further include a control winding that is wound around the “I” core in two open spaces. Such control winding can be wound at right angles to the magnetic flux that flows from the primary winding, for example. The inclusion of the “I” core between the primary and secondary cores typically disables the transformer (e.g., “Off” position) by decoupling the primary from the secondary, as the magnetic flux from the primary winding shall typically take the easy path through the “I” core rather than through the secondary “E” core. When such control winding is shorted, then magnetic flux from the primary no longer has an easy and available path through the “I” core, and will flow through the “E” core. It is to be appreciated that other arrangements (e.g., a planar square pot core) can also be employed and are well within the realm of the subject innovation. Moreover, the control winding typically requires no power nor delivers power, and control can be achieved by shorting the control winding via employing phase control for turn on, and zero current for turn off, wherein a triac and/or metal oxide semi conductor filed effect transistor (MOSFET) can also be employed.

In a related aspect, a planar transformer (4″×4″×1.4″ thick) can be employed with an intended power level of 1400 watts. The primary winding can have 37 turns (e.g., number 20 wire), the secondary winding 42 turns, and the control windings 20 turns. Moreover, saturation of the core is to be avoided, (e.g. to protect against distortion.)

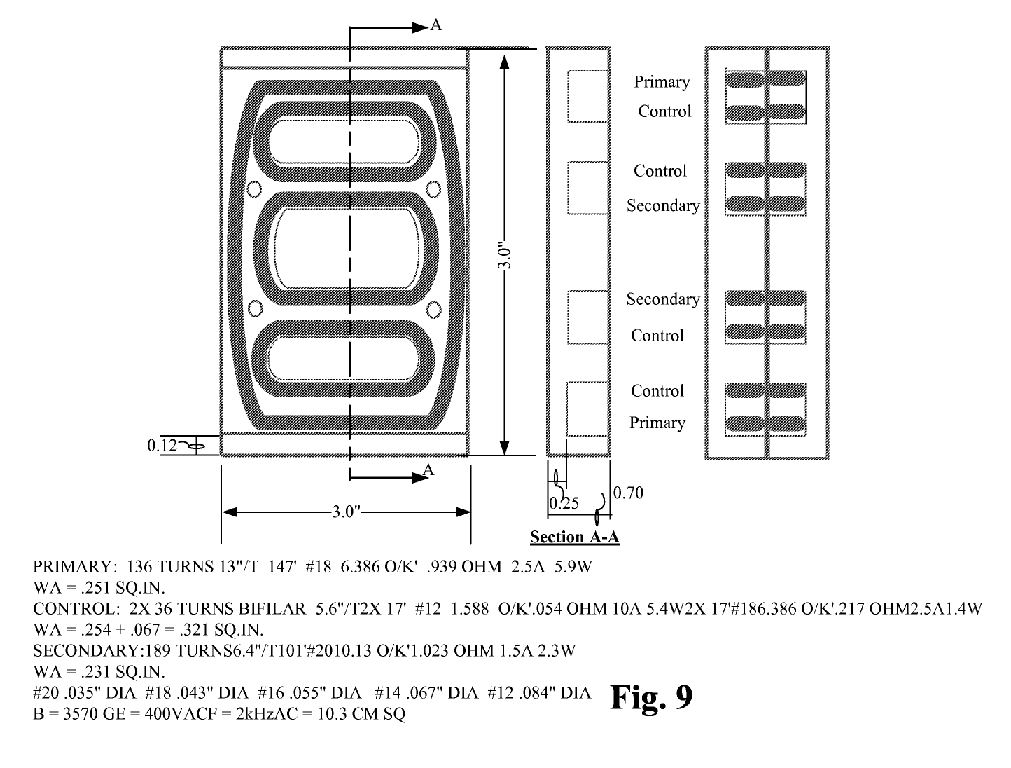

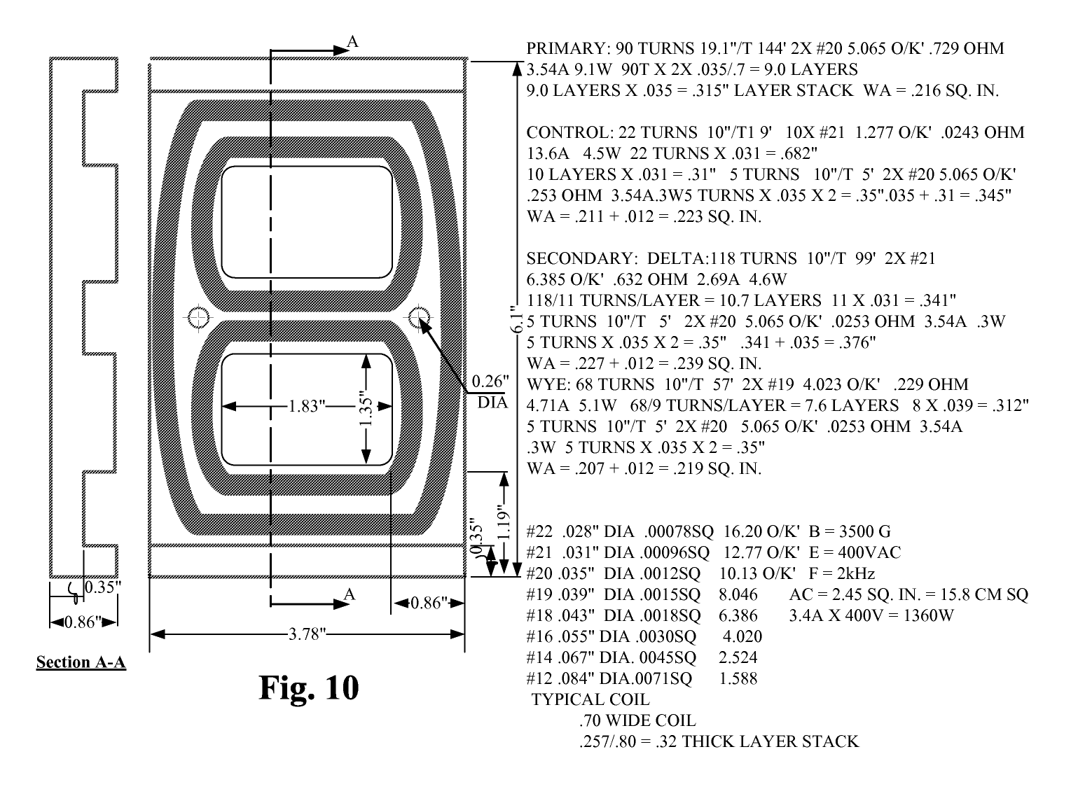

FIGS. 9, 10 illustrate exemplary cross sections and design specifications (e.g., number of turns, thickness of wires, and the like) associated with various aspects of the subject innovation. For example, the arrangement for: the control component, the primary coil, and the secondary coil of the transformer can be such that a magnetic coupling is supplied in substantially a same plane of the primary and/or secondary and/or control component, and a gap is avoided in the magnetic path to be controlled. Moreover, the primary winding can surround the control component and/or the secondary winding, in a same plane of magnetic coupling. Also, control of the magnetic flux of the subject innovation (e.g., via cross section selection of associated ferrite material) can be such as to avoid a saturation of cores associated with the transformer/control component. Such can mitigate a distortion of the material and corresponding losses. A plurality of such transformers can be electrically connected and aligned as part of a multiple output operation. Moreover, the transformer of the subject innovation can be employed as part of regulating three phase AC power with a high power voltage supply.

The subject innovation (e.g., in conjunction with distributing the electromagnetic flux through the bypass path) can employ various artificial intelligence based schemes for carrying out various aspects thereof. For example, a process for learning explicitly or implicitly when and to what extent a bypass should be employed can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

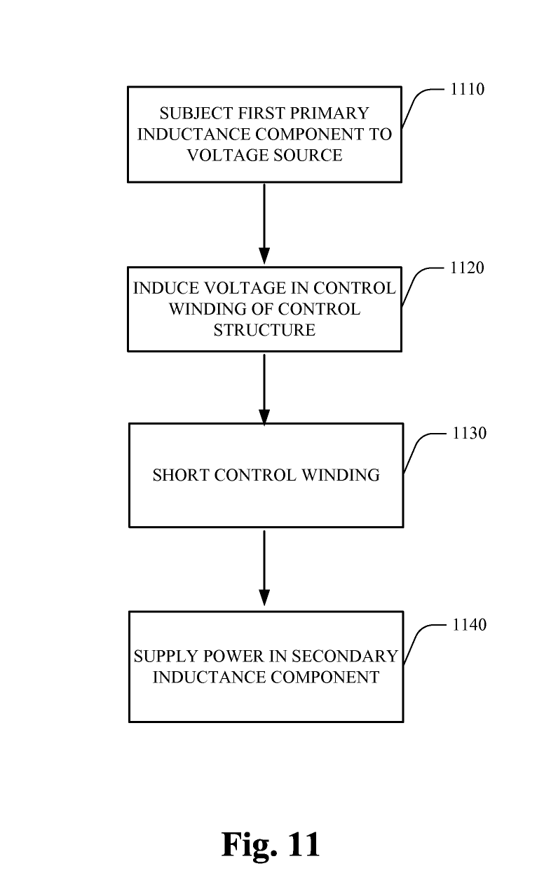

FIG. 11 illustrates an exemplary flow chart in accordance with an aspect of the subject innovation. While the exemplary method is illustrated and described herein as a series of blocks representative of various events and/or acts, the present innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the present innovation. Moreover, it will be appreciated that the exemplary method and other methods according to the innovation may be implemented in association with the method illustrated and described herein, as well as in association with other systems and apparatus not illustrated or described. Initially, and at 1110 primary inductance component (e.g., primary winding) associated with the transformer can be connected to a voltage source. Such voltage source can induce voltage in the control winding of the control structure, at 1120. Upon short of the control winding at 1130, the magnetic flux can then be forwarded to a secondary inductance component (e.g., secondary winding), and supply power therein at 1140.

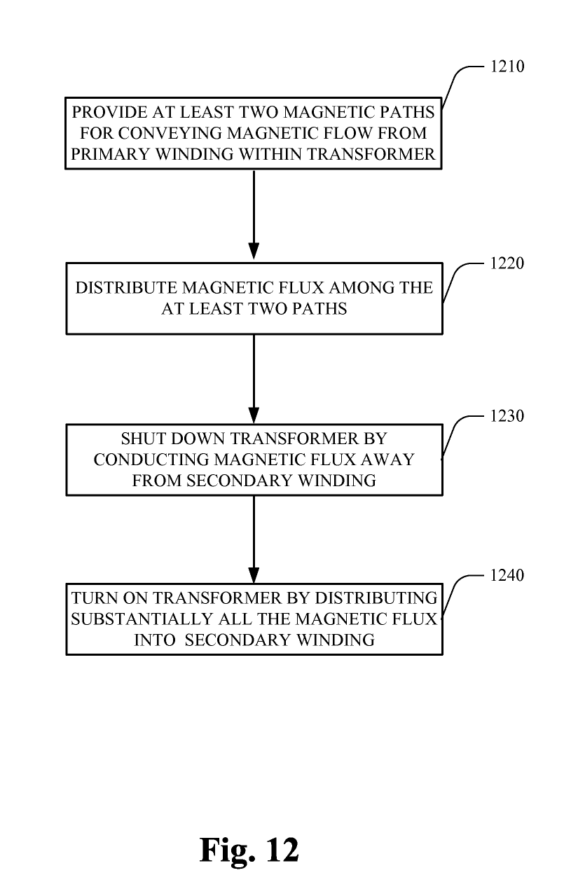

FIG. 12 illustrates a related methodology in accordance with an aspect of the subject innovation. Initially, and at 1210 at least two paths can be provided for conducting the magnetic flow from the primary winding to the secondary winding within the transformer. Subsequently, and at 1220 the magnetic flux can be distributed among the at least two paths. Such distribution can control operation of the transformer. For example, and as illustrated at 1230 the transformer can shut down by distributing the magnetic flux on the at least two paths in a manner as to conduct the magnetic flux away from the secondary winding. Likewise, the transformer can be turned on, by distributing the magnetic flux on the at least two paths, such that substantially all the magnetic flux is guided into the secondary winding, at 1240.

Although the innovation has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the innovation. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A transformer comprising:
a primary winding;
a secondary winding; and
a control component that regulates a magnetic flux between the primary winding and the secondary winding, via a distribution of the magnetic flux on at least two magnetic paths.

2. The transformer of claim 1, one magnetic path of the at least two magnetic paths is a bypass path that hinders availing the magnetic flux to the secondary winding.

3. The transformer of claim 2, another magnetic path of the at least two magnetic paths facilitates flow of the magnetic flux to the secondary winding.

4. The transformer of claim 1, a magnetic coupling for the primary winding, the secondary winding and the control component occur in a substantially same plane.

5. The transformer of claim 1 further comprising a non-saturated core.

6. The transformer of claim 1, the control component and the primary coil and the secondary coil are magnetically coupled in substantially a same plane.

7. The transformer of claim 1, a three phase AC power controllable by the control component.

8. The transformer of claim 1, the control component comprising a plate positioned between the first coil and the second coil.

9. The transformer of claim 8, the plate comprising a plurality of windings.

10. The transformer of claim 9, the plate with lead wires to induce a short circuit therein.

11. A method of regulating a magnetic flux in a transformer;
connecting a primary winding to a voltage source;
inducing a voltage in a control component magnetically coupled to the primary winding; and
supplying a short in the voltage of the control component.

12. The method of claim 11 further comprising bypassing a magnetic flux from the primary winding to the secondary winding.

13. The method of claim 13 further comprising turning on the transformer.

14. The method of claim 12 further comprising supplying the magnetic flux in substantially a same plane of the primary winding and the secondary winding.

15. The method of claim 11 further comprising inducing a magnetic flux from the primary winding to the secondary winding.

16. The method of claim 11 further comprising regulating a three phase AC power.

17. The method of claim 11 further comprising flowing the magnetic flux at right angles to windings of the control component.

18. The method of claim 11 further comprising selecting cross section of ferrite material associated with the control component.

19. The method of claim 11 further comprising avoiding a saturation of cores associated with the transformer.

20. A transformer comprising:
means for creating a magnetic flux transferable between a first winding and a second winding; and
means for regulating the magnetic flux between the first winding and the second winding via a distribution thereof on at least two magnetic paths.
